(19) United States
(12) Patent Application Publication
(10) Pub. No.: US 2026/0125874 A1
(43) Pub. Date: May 7, 2026

(54) SYSTEM AND METHOD FOR AUTOMATED INTERVENTION BASED ON AN EFFECTIVE HEIGHT OF A WORK MACHINE DURING TRANSPORT

(71) Applicant: Deere & Company, Moline, IL (US)

(72) Inventors: Amy K. Jones, Asbury, IA (US); Madeline T. Oglesby, Asbury, IA (US)

(21) Appl. No.: 18/935,763

(22) Filed: Nov. 4, 2024

(51) Int. Cl. E02F 9/00; B60Q 9/00; G01C 21/34

(52) U.S. Cl. CPC E02F 9/003; B60Q 9/00; G01C 21/3461

(57) ABSTRACT

A system and method are provided for facilitating safe transport of a work machine. During a transport stage for a work machine, wherein the work machine is positioned for transport with respect to a transport vehicle, a current effective height of the work machine is determined, for example relative to the ground surface. The current effective height may for example be based on a work implement assembly pose determined based on sensed relative positions of the various components. An intervention state for the transport stage may be determined based at least in part on the effective height of the work machine, for example by comparison to a threshold value, which may correspond to a minimum possible effective height for the type of machine. Output signals may be automatically generated to execute a specified intervention in a current transport plan, corresponding to the determined intervention state.

### FIELD OF THE DISCLOSURE

The present disclosure relates generally to the transport of work machines such as construction and forestry machines having ground-engaging work implements, and more particularly to systems and methods which alert drivers or otherwise intervene in the transport of work machines if the height of the work machine, namely the height of one or more components of the work implement in the transport position, may predictably result in unsafe traveling conditions.

### BACKGROUND

Work machines of this type may for example include, but are not limited to, excavator machines, tractors, loaders, or the like having wheeled or tracked ground engaging units supporting the undercarriage from the ground surface. Work machines within the scope of the present disclosure may also include stationary frames with one or more components moveable relative thereto. Many of these work machines may further include at least one work implement, which includes one or more components, that for example may be used to modify the terrain based on control signals from and/or in coordination with movement of the work machine.

Using the example of an excavator, when such a work machine is transported, the arm and bucket are curled under, and the boom is lowered so that the effective height (from the ground to the highest point on the machine) is minimized. If one or more of the aforementioned work implement components are not properly configured for transport, the effective height of the work machine may result in undesired costs and downtime. In one context, such costs may simply involve time, i.e., the need to stop and reposition the work machine. In other and more extreme contexts, such costs may relate to the work machine crashing into bridges, overpasses, signs, and other overhead objects along a travel route.

It would be desirable to automatically determine an unsafe transport condition associated with a work machine, and execute or otherwise prompt an intervention to avoid such costs.

### BRIEF SUMMARY

The current disclosure provides an enhancement to conventional techniques, at least in part by introducing a novel system and method for facilitating safe transport of a work machine from a work area, particularly with respect to transport on a separate transport vehicle where the work machine may otherwise strike overhead objects along a planned route.

Various embodiments as disclosed herein may utilize existing or supplemental machine-mounted sensors and communications with remote computing/ data centers to determine work machine kinematics, machine position, machine location, and jobsite information, for the purpose of determining the need for intervention, e.g., alerting operators/ business owners/ fleet managers to the presence of unsafe travel conditions.

In one particular and exemplary embodiment, a computer-implemented method is provided which includes, during a transport stage for a work machine, wherein the work machine is positioned for transport with respect to a transport vehicle, determining an effective height of the work machine relative to a ground surface to be traversed by the transport vehicle. An intervention state for the transport stage may be determined based at least in part on the effective height of the work machine. One or more output signals may be automatically generated to execute a specified intervention in a current transport plan, corresponding to the determined intervention state.

In one exemplary aspect according to the above-referenced method embodiment, determining the effective height of the work machine may comprise: determining a current pose of the work machine based on at least input signals from each of a plurality of sensors associated with respective components of a work implement assembly of the work machine; calculating a height of the work machine relative to a transport surface based on the current pose; and determining the effective height of the work machine based on the calculated height of the work machine relative to the transport surface further combined with a height of the transport surface relative to the ground surface to be traversed.

In another exemplary aspect according to the above-referenced method embodiment, upon determining that the work machine is in the transport stage, the work machine may be matched to a current transport vehicle having a retrievably stored transport surface height.

In another exemplary aspect according to the above-referenced method embodiment, geofence boundaries may be determined to define a work area for the work machine, wherein the transport stage is determined when a current position for the work machine is determined to move from inside the geofence boundaries to outside the geofence boundaries.

In another exemplary aspect according to the above-referenced method embodiment, the work machine may be determined to be in the transport stage based on detected movement of a frame of the work machine without corresponding movement of ground-engaging units supporting the frame.

In another exemplary aspect according to the above-referenced method embodiment, a model for a height of the work machine may be generated over time with respect to various combinations of inputs from each of the plurality of sensors and defining respective poses of the work machine, wherein the height of the work machine relative to the transport surface is further calculated by reference to the model with respect to the current pose.

In another exemplary aspect according to the above-referenced method embodiment, determining the effective height of the work machine may comprise: determining a current pose of the work machine based on at least input signals from each of a plurality of sensors associated with respective components of a work implement assembly of the work machine; capturing images comprising surroundings of the work machine using an image sensor associated with the work machine; and calculating an effective height of the work machine relative to the ground surface based on the current pose and the captured images.

In another exemplary aspect according to the above-referenced method embodiment, the intervention state may be determined at least in part by comparing the effective height to a threshold value. The threshold value may for example be based on a specified transport route or plan. The threshold value may for example correspond to a minimum possible height for the work machine, and in some embodiments further correspond to a specified range with respect to the minimum possible height for the work machine.

In another exemplary aspect according to the above-referenced method embodiment, the specified intervention may comprise an alert generated to an operator cab with respect to the transport vehicle and/or a user computing device associated with an operator of the transport vehicle.

In another exemplary aspect according to the above-referenced method embodiment, the specified intervention may comprise generation of a new transport route or plan to a user interface associated with the transport vehicle and/or a user computing device associated with an operator of the transport vehicle.

In another exemplary aspect according to the above-referenced method embodiment, the specified intervention may comprise control signals to automatically actuate one or more components of a work implement assembly of the work machine from a current pose to a transport pose corresponding to a minimum possible height for the work machine.

In another embodiment as disclosed herein, a system may comprise one or more processors configured, during a transport stage for a work machine, wherein the work machine is positioned for transport with respect to a transport vehicle, to direct the performance of steps according to the above-referenced method embodiment and optionally one or more of the exemplary aspects recited thereof.

Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side view representing an excavator as an exemplary work machine according to an embodiment of the present disclosure.

FIG. 2 is a side view representing the work machine of FIG. 1 mounted on a transport vehicle and defining an effective height from a ground surface.

FIG. 3 is a block diagram representing an exemplary control system according to an embodiment of the present disclosure.

FIG. 4 is a flowchart representing an exemplary embodiment of a method according to an embodiment of the present disclosure.

### DETAILED DESCRIPTION

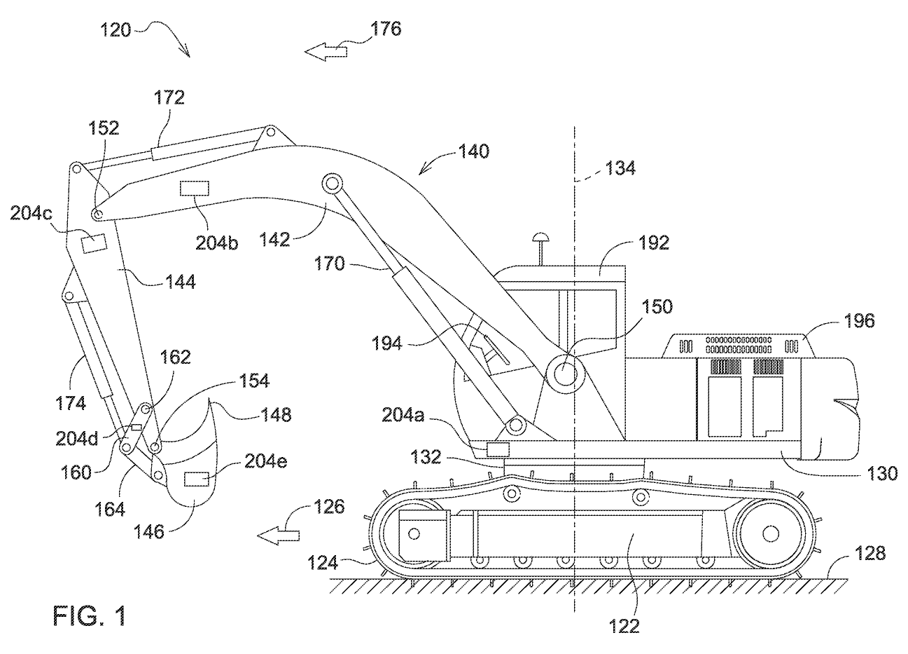

Referring now to FIGS. 1- 4, various embodiments may now be described of a system and method for preferably ensuring safe transport conditions in the context of a work machine.

FIG. 1 depicts a representative work machine 120 in the form of, for example, a tracked excavator machine. The work machine 120 includes an undercarriage 122 including first and second ground engaging units 124 (e.g., tracks). Only one of the ground engaging units is shown in FIG. 1. The other ground engaging unit is parallel to the illustrated ground engaging unit. The undercarriage includes respective first and second travel motors (not shown) for driving the first and second ground engaging units. The ground engaging units can be driven at the same velocity to move the undercarriage forward (e.g., in a forward direction indicated by an arrow 126) or backward (e.g., in a direction opposite the arrow 126) with respect to underlying terrain 128 (e.g., ground or other material supporting the undercarriage). The ground engagement units can also be driven at different velocities to enable the undercarriage to turn with respect to the terrain at an angle with respect to the forward direction represented by the arrow 126.

A main frame 130 is supported from the undercarriage 122 by a swing bearing 132 such that the main frame is pivotable about a main frame pivot axis 134 relative to the undercarriage. The pivot axis is substantially vertical when the underlying ground terrain 128 engaged by the ground engaging units 124 is substantially horizontal. (In the discussion herein, “horizontal” and “vertical” are referenced to a plane defined by the ground engaging units.) A swing motor (not shown) is configured to pivot the main frame on the swing bearing about the pivot axis relative to the undercarriage.

In the illustrated embodiment wherein the work machine 120 is an excavator, a work implement 140 extends from the main frame 130. In FIG. 1, the work implement is configured as a boom assembly. The work implement includes conventional components in the form of a boom 142, an arm 144, and a working tool 146. The working tool includes a point-of-interest (POI) 148, which engages portions of terrain (or other materials) to be moved or removed.

The boom 142 is pivotally connected to the main frame by a boom-to-frame linkage joint 150, which provides a horizontal pivot axis for the boom. The arm is pivotally connected to the boom at an arm-to-boom linkage joint 152. In the illustrated embodiment, the working tool 146 is an excavator shovel, which is pivotally connected to the arm 144 at a working tool-to-arm linkage joint 154, which is positioned near a free end of the arm. In the illustrated embodiment, a first end of a dogbone connector 160 is pivotally connected to the arm at a dogbone-to-arm linkage joint 162, which is displaced from the free end of the arm. A second end of the dogbone connector is pivotally connected to a tool link 164. In the context of the illustrated (excavator) work machine 120, the tool link is a bucket link.

The boom 142 is caused to move pivotally with respect to the main frame 130 by a boom actuator 170. The boom actuator can be a hydraulic motor. In the illustrated embodiment, the boom actuator is a hydraulic piston-cylinder unit that is selectively provided with pressurized hydraulic fluid to move the piston within the cylinder to extend or extract the piston. The pressurized hydraulic fluid is provided by a hydraulic system (not shown) and is controlled by manual controls, automatic controls, or a combination of manual and automatic controls. In a similar manner, the arm 144 is caused to pivot with respect to the boom by an arm actuator 172. The working tool (bucket) 146 is caused to pivot with respect to the arm by a working tool actuator 174 acting on the working tool via the dogbone connector 160, the dogbone-to-arm linkage joint 162, and the tool link 164.

The work implement 140 extends from the main frame 130 along a working direction (represented by arrow 176) of the work implement. In FIG. 1, the working direction is referenced to the main frame. Although illustrated as parallel to the forward direction (arrow 126) of the undercarriage 122, the working direction can be at an angle to the forward direction depending on the rotational position of the main frame with respect to the undercarriage. The working direction can also be described as a working direction of the boom 142.

As described herein, control of the work implement 140 relates to controlling the positioning of any one or more of the associated components (e.g., the boom 142, the arm 144, and the working tool 146). During a working operation or stage, such actions may be performed to control the movement of the point-of-interest 148 of the working tool with respect to material being manipulated (e.g., the material to be moved or removed). In preparation for a transport stage, such actions may be performed to place the different components of the work implement in a transport pose, for example a predetermined configuration for each of the respective work implement components relative to each other and the frame for a type of work machine.

The actuators 170, 172, 174 of the work implement 140 can be selectively actuated to pivotally move the boom 142 with respect to the respective boom-to-frame linkage joint 150, to pivotally move the arm 144 with respect to the arm-to-boom linkage joint 152, and/or to pivotally move the working tool 146 with respect to the working tool-to-arm linkage joint 154. By coordinating the movements of the boom, the arm, and the working tool of the work implement, the position for any respective location on the work implement (e.g., the point-of-interest of the working tool) can be controlled to a target location or along a target trajectory and at a target velocity.

In the illustrated embodiment, an operator’s cab 192 is located on the main frame 130. In the illustrated embodiment, the operator’s cab and the work implement 140 are both mounted on the main frame so that the operator’s cab faces in the working direction (arrow 176) of the work implement. In the illustrated embodiment, a control station 194 is located in the operator’s cab.

The main frame 130 also supports an engine 196 for powering the work machine 120. The engine can be a diesel internal combustion engine or another source of power. In the illustrated embodiment, the engine drives at least one hydraulic pump (not shown) to provide hydraulic power to the various operating systems of the work machine.

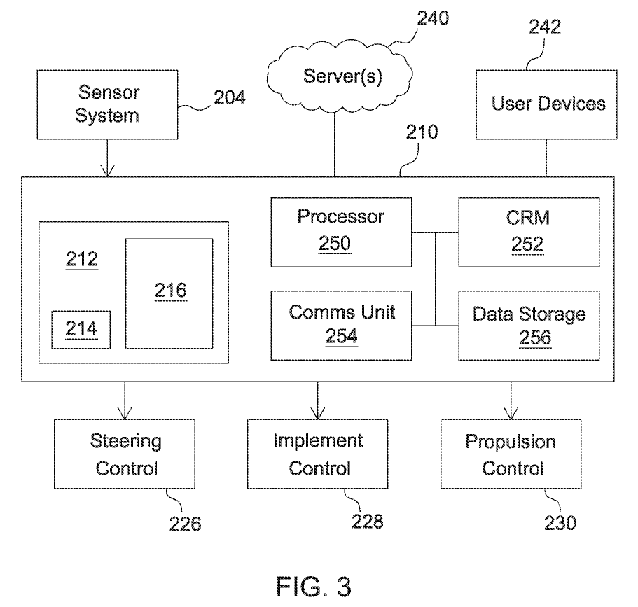

In the illustrated embodiment, a sensor system 204 (see FIG. 3) is also mounted on the work machine 120. As illustrated in FIG. 1, the sensor system includes a first sensor 204a mounted to the main frame 130, a second sensor 204b mounted to the boom 142, a third sensor 204c mounted to the arm 144, a fourth sensor 204d mounted to the dogbone connector 160, and a fifth sensor 204e mounted to the working tool 146.

In the illustrated embodiment, each of the first through fifth sensors is an inertial measurement unit (IMU). IMUs are tools that capture a variety of motion-based and position-based measurements, including, but not limited to, velocity, acceleration, angular velocity, and angular acceleration. IMUs include a number of sensors including, but not limited to, accelerometers, which measure (among other things) velocity and acceleration, gyroscopes, which measure (among other things) angular velocity and angular acceleration, and magnetometers, which measure (among other things) strength and direction of a magnetic field.

Generally, as discussed above, an accelerometer provides measurements, with respect to (among other things) force due to gravity, while a gyroscope provides measurements, with respect to (among other things) rigid body motion. The magnetometer provides measurements of the strength and the direction of the magnetic field, with respect to (among other things) known internal constants, or with respect to a known, accurately measured magnetic field. The magnetometer provides measurements of a magnetic field to yield information on positional, or angular, orientation of the IMU; similarly to that of the magnetometer, the gyroscope yields information on a positional, or angular, orientation of the IMU. Accordingly, the magnetometer may be used in lieu of the gyroscope, or in combination with the gyroscope, and complementary to the accelerometer, in order to produce local information and coordinates on the position, motion, and orientation of the IMU.

An accelerometer is an electro-mechanical device or tool used to measure acceleration (e.g., in meters per seconds squared (m/s²)), which is defined as the rate of change of velocity (e.g., in meters per second (m/s)) of an object. Accelerometers sense either static forces (e.g., gravity) or dynamic forces of acceleration (e.g., vibration and movement). An accelerometer may receive sense elements measuring the force due to gravity. By measuring the quantity of static acceleration due to gravity of the Earth, an accelerometer may provide data as to the angle the object is tilted with respect to the Earth, the angle of which may be established in an x-axis, y-axis, and z-axis coordinate frame. However, where the object is accelerating in a particular direction, such that the acceleration is dynamic (as opposed to static), the accelerometer produces data which does not effectively distinguish the dynamic forces of motion from the force due to gravity by the Earth. A gyroscope is a device used to measure changes in orientation, based upon the object’s angular velocity (rad/s) or angular acceleration (rad/s²). A gyroscope may constitute a mechanical gyroscope, a micro-electro-mechanical system (MEMS) gyroscope, a ring laser gyroscope, a fiber-optic gyroscope, and/or other gyroscopes as are known in the art. Principally, a gyroscope is employed to measure changes in angular position of an object in motion, the angular position of which may be established in an x-axis, y-axis, and z-axis coordinate frame.

In an embodiment, for each of at least one linkage joint associated with a work implement 140 (e.g., each coupled set of components in a boom assembly), sense elements from the received work implement position sensor output signals may be fused in an independent coordinate frame associated at least in part with the respective linkage joint, the independent coordinate frame of which is independent of a global navigation frame for the work machine 120, wherein for example measurements received by work implement position sensors 204 may be merged to produce a desired output in the work implement of the work machine.

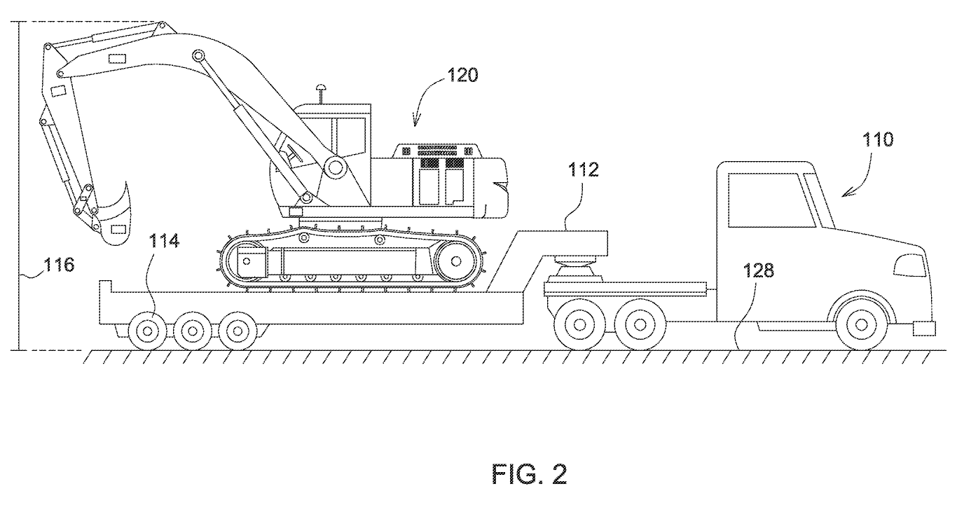

As schematically illustrated in FIG. 2, the work machine 120 may be mounted in preparation for a transport stage, and more particularly for example on a transport vehicle 110 comprising a transport trailer 112 being towed by a truck. The transport vehicle may for example be or otherwise include a removable goose neck trailer, step deck trailer, flatbed trailer, trailers including double drop decks, extended drop decks, or the like. In the illustrated example, the transport vehicle 110 has six axles 114, but any alternative number of axles and corresponding wheels may be considered within the scope of the present disclosure as depending for example on the size of the work machine 120 being transported, among other factors.

As illustrated in FIG. 2 and further described below, an effective height 116 of the work machine 120 may be defined while in a transport configuration on the transport vehicle 110. For the purposes of the present disclosure, an effective height may refer to an elevation difference between a calculated or otherwise determined highest point on the work machine 120 and a ground surface being traversed by the transport vehicle 110 having the work machine 120 mounted thereon.

As schematically illustrated in FIG. 3, the work machine 120 includes a control system that includes a controller 210. The controller may be part of the machine control system of the work machine, or it may be a separate control module. The controller is optionally mounted in the operator’s cab 192 at the control station 194. The machine controller can include a user interface 212 such as a control panel. The user interface can include a user interface tool 214 such as an input/output device (e.g., a keyboard, a joystick, or the like.) The user interface can also include a display 216.

The machine controller 210 is configured to receive input signals from some or all of various work implement position sensors 204a … 204e collectively defining, or otherwise part of, the sensor system 204. The sensors of the sensor system may typically be discrete in nature, but signals representative of more than one input parameter may be provided from the same sensor.

Although not expressly shown in FIG. 3, the sensor system 204 can also refer to signals provided from the machine control system. For example, in an embodiment machine location determining sensors may include a global navigation satellite system (GNSS) receiver.

Machine location determining sensors may additionally or in the alternative include for example ground speed sensors, steering sensors, or the like, or equivalent inputs from the machine control system.

Alternative or supplemental examples of work implement position sensors may include rotary pin encoders mounted at pivot pins to detect the relative rotational positions of the respective components, linear encoders mounted on hydraulic cylinders to detect the respective extensions thereof, and the like.

Additional sensors may be provided and configured to produce velocity measurement signals representing a velocity measurement of respective actuators, for example including hydraulic piston-cylinder units associated with respective components of a work implement (e.g., boom assembly).

The controller 210 can be configured to produce outputs to the user interface 212 for displaying information to the human operator. In addition, or in the alternative, the machine controller can be configured to generate control signals for controlling the operation of respective actuators, or generate signals for indirect control via intermediate control units, associated with a machine steering control system 226, a machine implement control system 228, and an engine speed (propulsion) control system 230. The machine controller can generate control signals for controlling the operation of various actuators, such as hydraulic motors or hydraulic piston-cylinder units of the boom actuator 170, the arm actuator 172, and the working tool actuator 174. The control signals from the controller can be received by electro-hydraulic control valves associated with the actuators such that the electro-hydraulic control valves control the flow of hydraulic fluid to and from the respective hydraulic actuators to control the actuation thereof in response to the control signal from the controller.

The controller 210 may include, or be associated with, a processor 250, a computer readable medium 252, a communication unit 254, data storage 256 such as for example a database network, and the aforementioned user interface (control panel) 212 having the display 216 and the user interface tool (e.g., input/output device) 214 by which a human operator may input instructions to the controller.

The controller described herein may be a single controller having all of the described functionality, or it may include multiple controllers wherein the described functionality is distributed among the multiple controllers. The data storage may generally encompass hardware such as volatile or non-volatile storage devices, drives, memory, or other storage media, as well as one or more databases residing thereon.

In the illustrated embodiment of FIG. 3, the controller 210 (and/or other processing units associated with the work machine 120) receives inputs from and generates outputs to, via a communications network, one or more remote computing devices such as a cloud server 240 computing environment for the performance of certain operations in a system as disclosed herein. The controller 210 may further receive inputs from and generate outputs to user computing devices 242 via a respective user interface, for example a display unit with touchscreen interface. Data transmission between, for example, a machine control system and a cloud server 240 and/or remote user interface associated with a user computing device 242 may take the form of a wireless communications system and associated components as are conventionally known in the art.

Various “computer-implemented” operations, steps or algorithms as described in connection with the controller 210 or in connection with alternative but equivalent computing devices or systems can be embodied directly in hardware, in a computer program product such as a software module executed by the processor 250, or in a combination of the two. The computer program product can reside in RAM memory, flash memory, ROM memory, EPROM memory, EEPROM memory, registers, hard disk, a removable disk, or any other form of computer-readable medium 252 known in the art. An exemplary computer-readable medium 252 can be coupled to the processor 250 such that the processor 250 can read information from, and write information to, the memory/storage medium 252. In the alternative, the computer-readable medium 252 can be integral to the processor 250. The processor 250 and the computer-readable medium 252 can reside in an application specific integrated circuit (ASIC). The ASIC can reside in a user terminal. In the alternative, the processor 250 and the medium 252 can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices (e.g., a combination of a digital signal processor (DSP) and a microprocessor), a plurality of microprocessors, one or more microprocessors in conjunction with a DSP core, or any other such configuration.

The communication unit 254 can support or provide communications between the machine controller 210 and external systems or devices, and/or support or provide communication interface with respect to internal components of the self-propelled work machine 120. The communications unit 254 can include wireless communication system components (e.g., via cellular modem, Wi-Fi® systems, Bluetooth® systems, or the like) and/or may include one or more wired communications terminals such as universal serial bus ports.

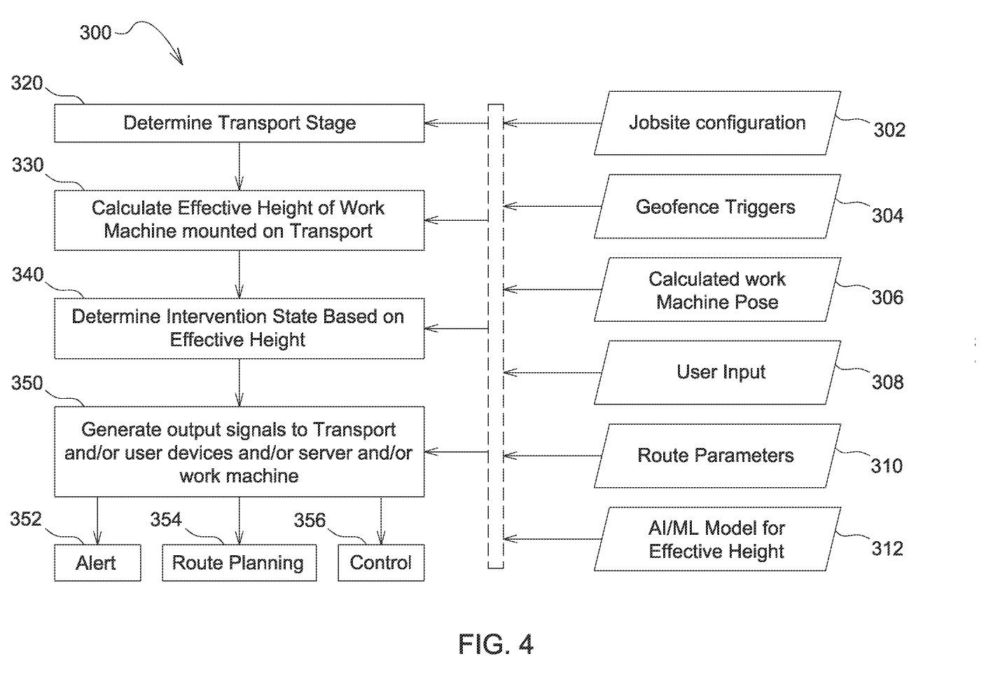

Referring next to FIG. 4, and still using an excavator as an example of the work machine 120 for illustrative purposes, an embodiment of a method 300 according to the present disclosure may now be described. While the illustrated embodiment may include a specific arrangement of steps, inputs, outputs, and the like, it may be understood that certain steps may be combined, performed in a different order, or even omitted altogether in other embodiments within the scope of the present disclosure, unless otherwise specifically noted herein.

The method 300 may include a step 320 of determining that the work machine has begun or otherwise is currently in a transport stage. In the context of the present disclosure, the transport stage may generally be contrasted with an operating stage for the work machine, and more particularly relates to a stage in which the work machine is mounted on a transport vehicle such as for example a towed truck bed or trailer.

In some embodiments, it may be appreciated that a work machine is not self-propelled but remains mounted on the bed or trailer during both of the operating and transport stages, or that the work machine and transport vehicle as otherwise described discretely herein may be integrated, wherein the transport stage may necessarily be distinguished from the operating stage based on the actual initiation of transport from a defined jobsite or work area configuration 302, or otherwise through or according to a route which may present the risk of accidents if the work implement assembly of the work machine is improperly positioned.

In an embodiment, the work machine may be determined to be in a transport stage based on input received from a user interface associated with the work machine, a user interface associated with the transport vehicle, or other authorized device. A first input representing a transition of the work machine into a transport stage, for example from a first device associated with an operator of the work machine, may be confirmed via a second input, for example from a second device associated with an operator of the transport vehicle. The second input from the second device may further identify the transport vehicle via which the work machine is to be transported.

In an embodiment, the work machine may be assigned to a jobsite or work area corresponding to an operating stage for the work machine. The work area configuration 302 may be defined for a particular operation by user input 308 from an operator of the work machine, a remote administrator, or the like using respective user interface tools, programs, applications, etc., or the work area configuration 302 may have predetermined and retrievable characteristics which are accessible to the controller, server, or the like executing a method as described herein.

The relevant characteristics for a work area to which the work machine is assigned may include geographical definitions or boundaries. For example, the work area may include or otherwise be defined in part by one or more geofence boundaries 304. The geofence boundaries may for example be defined in a global coordinate frame. As previously noted, the work machine may include one or more location sensors, such as for example a GNSS receiver, which enables tracking of the work machine location relative to the geofence boundaries. While the work machine remains within the geofence boundaries, in such an embodiment, the work machine may be considered to be in the operating stage. When the work machine is determined to have traversed the geofence boundaries, and thereby left the defined work area, the work machine may accordingly be considered to be in a transport stage.

In an embodiment, the work machine may automatically be determined to be in the transport stage upon detecting movement, for example a forward movement, of the work machine frame without a corresponding detected movement of the ground engaging units supporting the frame. In other words, if the wheels or tracks are not in operation, but location sensors mounted on the frame are indicating forward movement, it may reasonably be concluded that the work machine is being transported.

In various embodiments, one or more of the above-referenced techniques for determining that the work machine is in a transport stage may be utilized alone or in combination, for example using one technique to confirm a determination made according to another technique. A work machine may for example be mounted on a trailer, wherein movement of the trailer causes movement of the work machine frame without driving of the ground engaging tracks or wheels, but while the work machine and transport vehicle have not yet exited the defined work area. Accordingly, for a given application it may be preferred that a transport stage is not defined until both triggers have been detected, or a transport stage may be defined based on either trigger, with the difference in modes being user-selectable in some embodiments.

The method 300 may include a step 330 of calculating or otherwise determining an effective height of the work machine, namely, a maximum height for any component of the work machine relative to a ground surface.

In an embodiment, the effective height may be calculated or otherwise determined based on a current pose 306 of the work machine, and more particularly based on a current pose of the work implement assembly relative to the work machine frame. The current pose may be determined based on at least input signals from each of a plurality of sensors associated with respective components of a work implement assembly, wherein positions and orientations of the various components relative to each other and to the machine frame may be determined as previously discussed herein. A height of the work machine may accordingly be calculated relative to a transport surface based on the current pose, wherein the effective height of the work machine may further be determined based on the calculated height of the work machine relative to the transport surface, further combined with a height of the transport surface relative to the ground surface to be traversed.

As previously noted, and using an excavator as an example of the work machine, it is generally understood that undesirable costs and downtime may result from transport if the boom, arms, and the like are not positioned correctly when the work machine is transported on a work vehicle such as a truck. Accordingly, during a transport stage for the excavator, a preferred pose for the work implement assembly may include the arm and bucket being curled under, and the boom lowered so that the effective height (from the ground to the highest point on the machine) is minimized.

One example for calculating the height of the work machine in association with a determined current pose may include development of a height model 312 for the work machine over time. In some embodiments, the model may be developed over time using machine learning or the equivalent. Various combinations of inputs may be received from each of the work assembly components to define respective poses. For each pose, a maximum height for the work machine may be actually measured and correlated in the model with the respective pose, wherein identifying the pose in association with a subsequent iteration enables the retrieval of the known maximum height. In some cases, the model may simply take the form of a look-up table. In other cases, a model for the work machine may include sufficient information for each component of the work implement assembly that determined relative positions and orientations for the components relative to each other enable reasonably precise estimation of a maximum height.

In an embodiment, the height of the transport surface may be provided via user input 308, for example from an operator of the transport vehicle, or other relevant user interface.

In another embodiment, the height of the transport surface may be retrievably stored in a data repository accessible to the controller, server, or other processing unit executing the method, and retrieved therefrom during the transport stage by matching the work machine to the transport vehicle upon which it is mounted.

In an embodiment, rather than (or supplemental to) relying on a known height for the transport surface, one or more images may be captured using imaging devices mounted on the work machine. The images or characteristics of the work machine surroundings as extracted therefrom may be fused with inputs from other devices, for example perception sensors such as lidar, laser, ultrasonic, radar sensors, or the like, to identify the relative distance and orientation with respect to one or more points and thereby calculate a height of at least one imaging device. With the height of the imaging device being known, further in view of a determined current pose of the work implement assembly, an effective height of the work machine relative to the ground surface may accordingly be calculated.

The method 300 may include a step 340 of determining an intervention state for the work machine, based at least in part on the effective height, for example as calculated in step 330.

In an embodiment, an intervention state may be determined at least in part by comparing the effective height to a threshold value. In one example, the threshold value may be defined based on a type and/or model of the work machine, or a type and/or model of an attachment thereto as the work implement or a component thereof.

In another example, a relevant threshold value may be defined based on a transport plan or associated transport route parameters 310. For example, if a specified route would carry the work machine under relatively low overpasses, or through an area which is known to include overhanging signs, trees, or the like, the threshold value may correspond to a minimum known height for any of the aforementioned obstacles.

In another example, a relevant threshold value may further be defined based on a minimum possible height for the work machine, based on the actual physical characteristics of the work implement assembly. In this example, any pose for the work implement assembly components which results in an effective height varying from a minimal (or optimal) effective height may be deemed to violate the threshold. Alternatively, a range of permissible effective heights may be defined from the minimum possible value.

The examples of intervention states referenced above substantially relate to the effective height of the work machine, but in some cases intervention states may be further defined based on other parameters. In some embodiments, further intervention states may relate to the work machine being mounted upon or otherwise matched to a transport vehicle that is not approved or otherwise inappropriate for supporting or capably securing that type or model of work machine. In some contexts, specific routes may be required for transport of the work machine, and if the matched transport vehicle lacks permits or other requirements for those specific routes, a further intervention state may be defined.

The method 300 may include a step 350 of automatically generating output signals, for example based at least in part on the determined intervention state, to any one or more of a device associated with the transport vehicle, a device associated with an operator, administrator, or the like, a device associated with the work machine, a remote server, etc.

The output signals generated in step 350 may be configured to provide an alert (step 352) to any relevant user, such as for example the transport vehicle operator. Alerts within the scope of the present disclosure may be audible, visual, or combinations thereof, and may be delivered for example to a user interface associated with the computing devices for respective users, whether onboard the transport vehicle, mobile devices, or the like.

The output signals generated in step 350 may be provided to generate, or otherwise initiate generation of, a new or revised travel route (step 354) for the transport vehicle carrying the work machine. A computing environment within the scope of the present disclosure may be configured to analyze any number of available routes between a current location and a target destination, further with respect to the known variables including but not limited to the effective height of the work machine, the traversable heights for each route or segments thereof, estimated weight of the work machine-transport vehicle combination with respect to weight limits or other load requirements for each route or segments thereof, capabilities of the transport vehicle with respect to elevation changes associated with each route or segments thereof, and the like. Certain jurisdictions may for example have laws or other regulations regarding weight, height, width, length, or other relevant parameters for the machine-vehicle combination. Based on the analyzed routes, further optionally in view of user-selectable preferences, the route may be initially provided for the transport stage, or modified in real time based on any observed changes in conditions.

The output signals generated in step 350 may be provided to automatically actuate one or more components or aspects of the work machine (step 356), for example to reduce, and potentially minimize, the effective height of the work machine during the transport stage.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C.

Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments.

What is claimed is:

1. A computer-implemented method, comprising:
during a transport stage for a work machine, wherein the work machine is positioned for transport with respect to a transport vehicle, determining a current effective height of the work machine;
determining an intervention state for the transport stage, based at least in part on the current effective height of the work machine; and
automatically generating one or more output signals to execute a specified intervention in a current transport plan, corresponding to the determined intervention state.

2. The method of claim 1, wherein the current effective height of the work machine is determined based at least in part on a current pose of the work machine, the current pose being determined based on at least input signals from each of a plurality of sensors associated with respective components of a work implement assembly of the work machine.

3. The method of claim 2, wherein the current effective height of the work machine is determined by:
calculating a maximum height of the work machine relative to a transport surface based on the current pose; and
determining the effective height of the work machine based on the calculated maximum height of the work machine relative to the transport surface further combined with a determined height of the transport surface relative to a ground surface to be traversed.

4. The method of claim 3, comprising, upon determining that the work machine is in the transport stage, matching the work machine to a current transport vehicle having a retrievably stored transport surface height.

5. The method of claim 4, wherein geofence boundaries are determined to define a work area for the work machine, and the transport stage is determined when a current position for the work machine is determined to move from inside the geofence boundaries to outside the geofence boundaries.

6. The method of claim 4, wherein the work machine is determined to be in the transport stage based on detected movement of a frame of the work machine without corresponding movement of ground-engaging units supporting the frame.

7. The method of claim 3, comprising generating a model for a height of the work machine over time with respect to various combinations of inputs from each of the plurality of sensors and defining respective poses of the work machine, wherein the height of the work machine relative to the transport surface is further calculated by reference to the model with respect to the current pose.

8. The method of claim 1, wherein determining the current effective height of the work machine comprises:
determining a current pose of the work machine based on at least input signals from each of a plurality of sensors associated with respective components of a work implement assembly of the work machine;
capturing images comprising surroundings of the work machine using an image sensor associated with the work machine; and
calculating an effective height of the work machine relative to a ground surface based on the current pose and the captured images.

9. The method of claim 1, wherein the intervention state is determined at least in part by comparing the current effective height to a threshold value.

10. The method of claim 9, wherein the threshold value is based on a specified transport route or plan.

11. The method of claim 9, wherein the threshold value corresponds to a minimum possible height for the work machine.

12. The method of claim 11, wherein the threshold value further corresponds to a specified range with respect to the minimum possible height for the work machine.

13. The method of claim 1, wherein the specified intervention comprises an alert generated to an operator cab with respect to the transport vehicle and/or a user computing device associated with an operator of the transport vehicle.

14. The method of claim 1, wherein the specified intervention comprises generation of a new transport route or plan to a user interface associated with the transport vehicle and/or a user computing device associated with an operator of the transport vehicle.

15. The method of claim 1, wherein the specified intervention comprises control signals to automatically actuate one or more components of a work implement assembly of the work machine from a current pose to a transport pose corresponding to a minimum possible height for the work machine.

16. A system comprising one or more processors configured, during a transport stage for a work machine, wherein the work machine is positioned for transport with respect to a transport vehicle, to:
determine a current effective height of the work machine;
determine an intervention state for the transport stage, based at least in part on the current effective height of the work machine; and
automatically generate one or more output signals to execute a specified intervention in a current transport plan, corresponding to the determined intervention state.

17. The system of claim 16, wherein determining the current effective height of the work machine comprises:
determining a current pose of the work machine based on at least input signals from each of a plurality of sensors associated with respective components of a work implement assembly of the work machine;
calculating a height of the work machine relative to a transport surface based on the current pose; and
determining the current effective height of the work machine based on the calculated height of the work machine relative to the transport surface further combined with a determined height of the transport surface relative to a ground surface to be traversed.

18. The system of claim 17, wherein the one or more processors are configured, upon determining that the work machine is in the transport stage, to match the work machine to a current transport vehicle having a retrievably stored transport surface height, wherein geofence boundaries are determined to define a work area for the work machine, and the transport stage is determined when a current position for the work machine is determined to move from inside the geofence boundaries to outside the geofence boundaries.

19. The system of claim 18, wherein the one or more processors are configured, upon determining that the work machine is in the transport stage, to match the work machine to a current transport vehicle having a retrievably stored transport surface height, wherein the work machine is determined to be in the transport stage based on detected movement of a frame of the work machine without corresponding movement of ground-engaging units supporting the frame.

20. The system of claim 16, wherein determining the current effective height of the work machine comprises:
determining a current pose of the work machine based on at least input signals from each of a plurality of sensors associated with respective components of a work implement assembly of the work machine;
capturing images comprising surroundings of the work machine using an image sensor associated with the work machine; and
calculating a current effective height of the work machine relative to the ground surface based on the current pose and the captured images.
